(19) United States
(12) Patent Application Publication
(10) Pub. No.: US 2011/0317337 A1
(43) Pub. Date: Dec. 29, 2011

(54) CONNECTION ARRANGEMENT FOR A RACK HOUSING AND RACK HOUSING

(75) Inventors: Bernhard Homölle, Paderborn (DE); Reinhard Zörner, Paderborn (DE); Gerold Scheidler, Bad Wunnenberg (DE)

(73) Assignee: Fujitsu Technology Solutions Intellectual Property GmbH, Munchen (DE)

(21) Appl. No.: 13/107,294

(22) Filed: May 13, 2011

(30) Foreign Application Priority Data
Jun. 23, 2010 (DE) 20 2010 009 423.2

(51) Int. Cl. H02B 1/34; H02B 1/015

(52) U.S. Cl. 361/622; 361/627

(57) ABSTRACT

A connection arrangement for a rack housing with a plurality of load zones includes at least one internal connection device each having at least one phase conductor and one neutral conductor for each of the plurality of load zones, and a distributor device that electrically couples the internal connection devices with at least two external lines that are electrically independent from each other for connection to different phases and/or different energy sources, wherein each of the internal connection devices is coupled directly to the distributor device independent of the other internal connection devices, and the distributor device for distribution of a voltage of the at least two external lines to the individual load zones of the rack housing is arranged so that a voltage failure of an individual external line does not lead to failure of all of the load zones.

### RELATED APPLICATION

This application claims priority of German Patent Application No. 20 2010 009 423.2, filed Jun. 23, 2010, herein incorporated by reference.

### TECHNICAL FIELD

This disclosure relates to a rack housing having a plurality of plug-in positions for receiving plug-in components and, in particular, to a connection device for such a rack housing.

### BACKGROUND

Rack housings are widely known. In particular, in the field of telecommunications and information technology, for reasons of simpler serviceability and increase of component density, plug-in components with electrical or electronic components are often mounted in common rack housings. The rack housing takes over, in addition to the simple task of holding the plug-in components, in part, also central tasks, such as the supply of an operating voltage, cooling of the plug-in components, or connection of the plug-in components to external networks.

In particular, in data-processing centers, a plurality of plug-in components in the form of server computers are often arranged in a common rack housing, for example, in 19″ format. In larger data-processing centers, in particular, in so-called “server farms,” several rack arrangements are also arranged in rows one next to the other or one behind the other.

One disadvantage of known rack housings is that they usually must be delivered in different variants for different countries. In particular, for the connection of the rack housing to a power network, there are often differences between the local standards of individual countries that require modifications to the rack housing. In particular, the plug standard, the voltage, the maximum operating current, as well as the number of phases of a multi-phase, AC mains power network supplied by the local power provider or of another energy source vary.

If the plug-in components are connected directly to the power network, then the individual plug-in components must be adapted to the corresponding conditions of the local power network. The provision of different, localized versions of plug-in components on one hand and/or of rack housings on the other hand generates considerable extra costs for the manufacturer of the rack systems. There is also the risk that the reliability of the function cannot be guaranteed under all connection conditions.

It could therefore be helpful to provide a connection arrangement for a rack housing or a rack housing with a connection arrangement that is suitable for use in different regions with different power networks and other energy sources. It could also be helpful to have the greatest possible functional reliability of components held therein under as many connection conditions as possible.

### SUMMARY

We provide a connection arrangement for a rack housing with a plurality of load zones, including at least one internal connection device each having at least one phase conductor and one neutral conductor for each of the plurality of load zones, and a distributor device that electrically couples the internal connection devices with at least two external lines that are electrically independent from each other for connection to different phases and/or different energy sources, wherein each of the internal connection devices is coupled directly to the distributor device independent of the other internal connection devices, and the distributo device for distribution of a voltage of the at least two external lines to the individual load zones of the rack housing is arranged so that a voltage failure of an individual external line does not lead to failure of all of the load zones.

We also provide a rack housing including the connection device and a plurality of plug-in positions, each for holding one plug-in component, wherein the plug-in positions are electrically connected to different internal connection devices so that plug-in components held therein are allocated to different load zones.

### BRIEF DESCRIPTION OF THE DRAWINGS

FIG. 1 shows a server rack with a plurality of load zones according to a first example.

FIG. 2 shows a first connection schematic for connection of the server rack.

FIG. 3 shows a second connection schematic for connection of the server rack.

FIG. 4 shows a third connection schematic for connection of the server rack.

FIG. 5 shows a fourth connection schematic for connection of the server rack.

FIG. 6 shows a fifth connection schematic for connection of the serve rack.

### DETAILED DESCRIPTION

It will be appreciated that the following description is intended to refer to specific examples of structure selected for illustration in the drawings and is not intended to define or limit the disclosure, other than in the appended claims.

We provide a connection arrangement for a rack housing with a plurality of load zones. The connection arrangement has at least one internal connection device each with at least one phase conductor and one neutral conductor for each of the plurality of load zones. The connection arrangement also has a distributor device for the electrical coupling of the internal connection devices with at least two external lines electrically independent from each other for connection to different phases and/or different energy sources. Each of the internal connection devices is coupled directly with the distributor device independent of the other internal connection devices, and the distributor device is designed for the distribution of the voltage of the at least two external lines to the individual load zones of the rack housing so that failure of one individual external line does not lead to failure of all of the load zones.

Through the distributor device, the internal connection devices for the supply of the plurality of load zones and two external lines for connection of the rack housing to at least one energy source, in particular, a power network, are decoupled from each other. In addition, division of the rack housing into a plurality of load zones allocated to the different external lines permits prevention of a simultaneous failure of components arranged in different load zones. Through the plurality of load zones, a distribution of the input current to the multiple external lines can also be generated simultaneously.

The at least two external lines may be contained in different mains lines for independent connection to at least two energy sources, wherein the distributor device is designed such that failure of one of the energy sources or separation of one of the different mains lines does not lead to failure of all of the load zones. Through the use of two mains lines that are independent from each other, line and source redundancy can be achieved.

The connection arrangement has at least two external lines that may be different phase lines of one multi-phase mains line, wherein the distributor device is designed such that failure of one of the phases does not lead to failure of all of the load zones. Through a connection by a multi-phase mains line and distribution of the load to different phases of the multi-phase mains line, phase redundancy can be created for the connection arrangement.

The source redundancy and phase redundancy can also be combined with each other.

The connection arrangement may be designed for connection to different supply voltages, wherein the distributor device is designed to combine the different supply voltages with each other so that for use in a different power network, the plurality of internal connection devices of the load zones are supplied with an essentially uniform operating voltage. Through a different combination of the individual phases, for example, with respect to a common neutral conductor or with respect to another phase, for example, a phase that is adjacent or opposite in the phase diagram, an essentially uniform operating voltage for operation of the internal plug-in component can be generated from supply voltages of different magnitudes. The use of locally modified plug-in components in the rack arrangement can then be eliminated.

The problem stated above is likewise addressed with a rack housing having a plurality of plug-in positions each for reception of a plug-in component, wherein the plug-in positions are electrically connected to different internal connection devices so that plug-in components held therein are allocated to different load zones.

The rack housing may have at least two additional plug-in positions to hold redundant auxiliary components, wherein the at least two additional plug-in positions are electrically connected to different internal connection devices so that auxiliary components held therein are allocated to different load zones. By holding redundant auxiliary components in different load zones, in particular, total failure of the server system arranged in the rack housing can be avoided.

The rack housing may have at least one additional plug-in position to hold an auxiliary component, wherein the at least one additional plug-in position is electrically connected to at least two different internal connection devices so that an auxiliary component held therein is allocated to at least two different load zones. Through the simultaneous allocation of an auxiliary component to two different load zones, operational reliability with respect to a particularly important auxiliary component of the rack housing can be achieved.

Additional constructions are disclosed in the examples described below. Our connection arrangements will be explained in detail below using different examples with reference to the drawings.

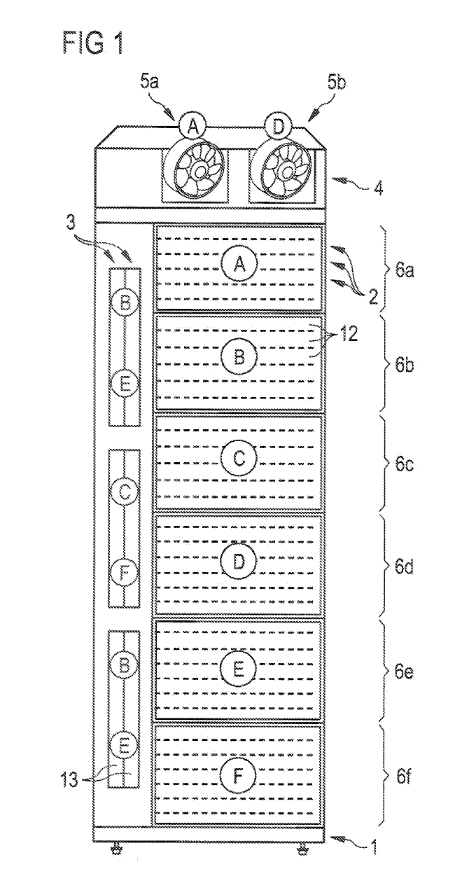

In FIG. 1, a rack housing 1 is shown. The rack housing 1 has 40 plug-in positions 2. The plug-in positions 2 are used to hold plug-in components 12 in the form of server computers in 19″ rack inserts with one unit of height (so-called “1U rack insert”). The plug-in components 12 are arranged one above the other in the example shown in FIG. 1.

In addition, the rack housing 1 has six additional plug-in positions 3. The plug-in positions 3 are used for reception of auxiliary components 13 to control the plug-in components 12 of the plug-in positions 2. For example, network switches or control devices can be held in the additional plug-in positions 3, with these network switches or control devices switching or controlling the data streams between the individual plug-in components 12 held in the plug-in positions 2.

On the rack housing 1, a removable cooling device 4 with two fan units 5 is arranged. The cooling device 4 is used for central cooling of the plug-in components 12 held in the plug-in positions 2. Optionally, it is likewise used for cooling the auxiliary components 13 held in the additional plug-in positions 3.

The rack housing 1 has, in this example, six load zones A to F independent of each other. The individual plug-in components 12, auxiliary components 13, and other components of the rack housing 1, such as, for example, the fan units 5, are allocated to the load zones A to F.

The plug-in positions 2 each have a plug connector not shown in FIG. 1 for the simple electrical connection of plug-in components 12. For example, the plug connector involves a plug connector mounted rigidly to a back wall at the height of the 40 plug-in positions and is in accordance with the IEC 320 standard. The additional plug-in positions 3 likewise have connection devices for the power supply of the auxiliary components 13. For example, in the region of the plug-in positions 3, mains cables with plugs constructed in accordance with the IEC 320 standard are provided. The fan units 5 of the removable cooling device 5 are connected by mains plugs to power sockets of the rack housing 1.

The plug-in positions 2 are divided into blocks 6a to 6f allocated to the load zones A to F. In that example, the blocks 6a and 6b each comprise six plug-in positions 2 and the remaining blocks 6c to 6f each comprise seven plug-in positions 2. In that example, the two fan units 5a and 5b are allocated to the different load zones A and D of the rack housing 1.

Each of the additional plug-in positions 3 is allocated to two different load zones B and E or C and F. With the illustrated allocation, a source redundancy for auxiliary components with two redundant network units is established. Alternatively, for the use of auxiliary components 13 with two redundant network units, for example, it is also possible to allocate one network unit to load zone A and another network unit to load zone E, wherein, in this way, as discussed later, both a phase redundancy and also an energy source redundancy of the associated auxiliary component 13 can be achieved. Obviously, a functional redundancy could also be established by doubling the auxiliary components, as implemented with respect to conventional plug-in components 12 with, as a rule, only one network unit.

The different load zones A to F are in competition with each other to the extent that, in particular, simultaneous failure of certain load zones is to be avoided. In that example, in particular, simultaneous failure of spatially adjacent, logically competing, and/or functionally complementary load zones should be avoided. In particular, not all components of the same type or with the same task should fail simultaneously.

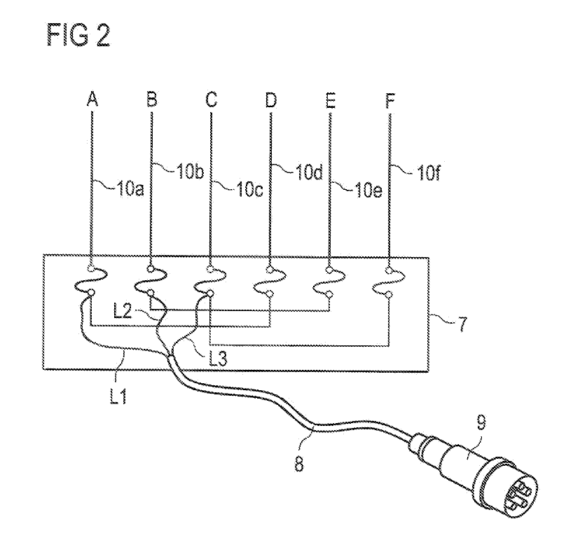

In FIG. 2, a first connection schematic for the rack housing 1 according to FIG. 1 is shown. The core of the connection schematic is a distributor device 7 that is responsible for the distribution of voltages of a power network to the different load zones A to F of the rack housing 1.

In the example according to FIG. 2, the distributor device 7 can be connected by a common mains line 8 and a common mains plug 9 to a power network. The mains plug 9 involves a three-phase CEE/IEC plug for connection to three-phase, AC mains power networks with three phase lines L1 to L3 and a separate neutral conductor N that is, however, not shown in FIG. 2. An operating current of up to 32 A can be transmitted by each phase line of the mains line 8.

Within the distributor device 7, the phase lines L1 to L3 of the power network are distributed to the connection lines 10a to 10f for supplying the individual load zones A to F. Each phase line L1 to L3 is allocated to two different load zones A and D, B and E, and also C and F.

Under consideration of the load zones shown in FIG. 1, it follows that even if there is a failure of one of the phase lines L1 to L3, all of the plug-in servers 12 or auxiliary components 13 never fail at the same time. Indeed, in the case of the failure of one phase line L1, L2, or L3, individual plug-in components 12 that are arranged in the associated block 6 of plug-in positions 2 do fail, but the remaining system with additional, usually identical plug-in components 12 continues to function so that for the provision of corresponding measures for the load distribution, operation of the server rack as a whole is maintained. In this respect, redundancy for the rack housing 1 against failure of a phase is created.

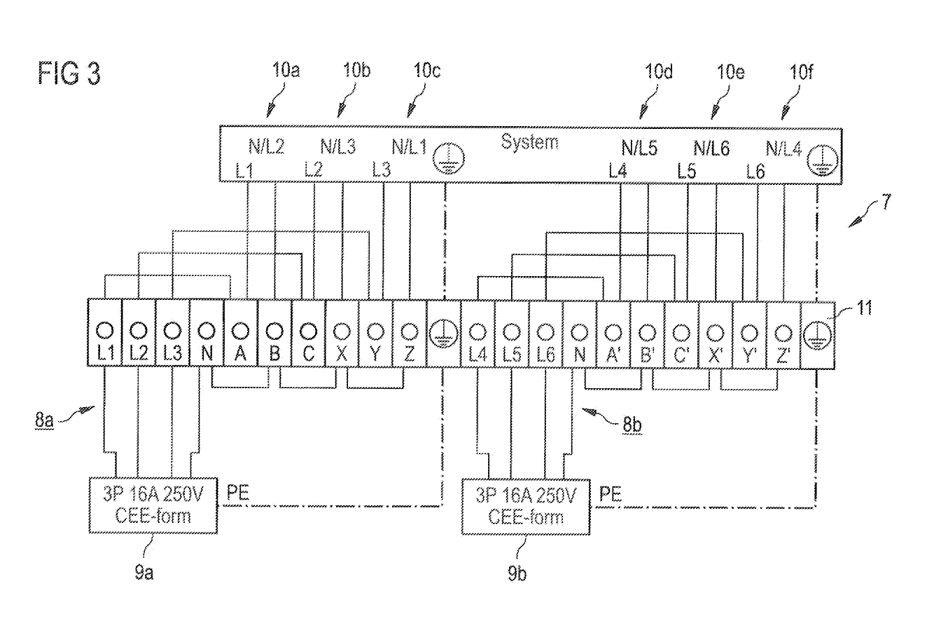

FIG. 3 shows a further improved connection schematic for the distributor device 7. In that example, two three-phase CEE plugs 9a and 9b in accordance with the IEC 60309 standard are provided with a maximum load of 16 A for each phase line L1, L2, and L3.

An advantage of the provision of separate mains lines 8a and 8b, as well as mains plugs 9a and 9b, is allowing yet a further increase in operational reliability. In particular, even for the unintentional separation of one of the mains plugs 9a or 9b, the rack housing 1 can continue to operate with a part of the plug-in components 12 arranged therein.

In addition, it is possible to connect the rack housing 1 simultaneously to two different energy sources, for example, to different sub-power networks of a building installation or to a power network and an emergency power supply, such as, for example, an emergency power generator or an uninterruptible power supply unit (USV [UPS]). Even in the case of the failure of one of the energy sources, for example, if a safety device is triggered, the rack housing 1 can continue to operate with the plug-in components 12 arranged therein. In this respect, in addition to the phase redundancy, a redundancy with respect to the different energy sources is created.

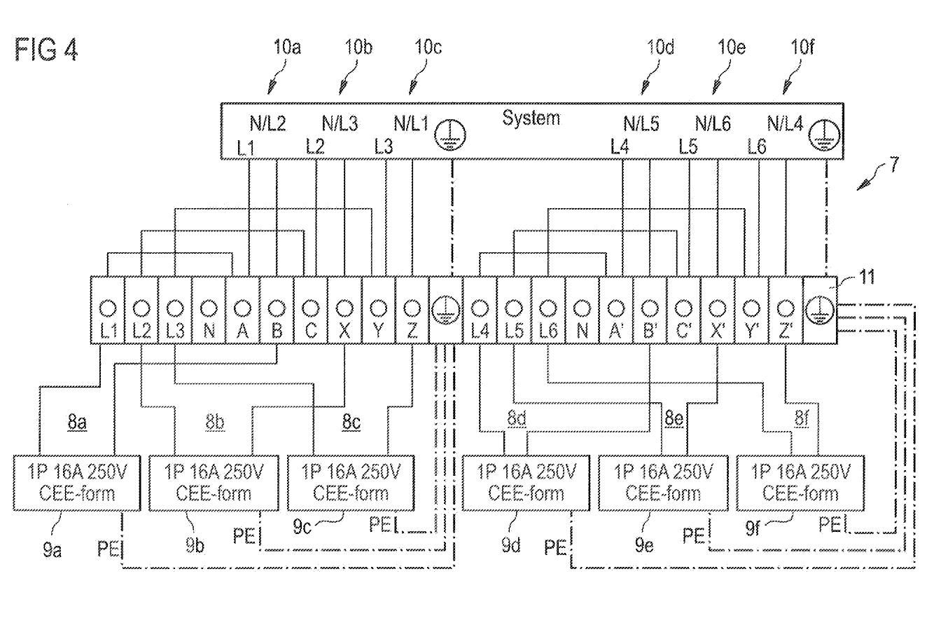

FIG. 4 shows another connection schematic for the connection of the rack housing 1 to three different phase lines of two energy sources by means of six different mains lines 8a to 8f and associated mains plugs 9a to 9f. For example, the distributor device 7 can be connected by six single mains plugs 9a to 9f to conventional power sockets with only one phase L and one neutral conductor N. To protect the system against the failure of individual phases, in the connection of the rack housing 1, preferably care must be taken that the power sockets are allocated, if possible, to different phase lines L1 to L3.

For the electrical operational reliability of the rack housing 1, however, this allocation plays no role, because, in particular, there is no direct connection between the different, adjacent neutral conductors of the internal connection lines 10a to 10f of the load zones A to F on one hand or the external mains lines 8a to 8f on the other hand.

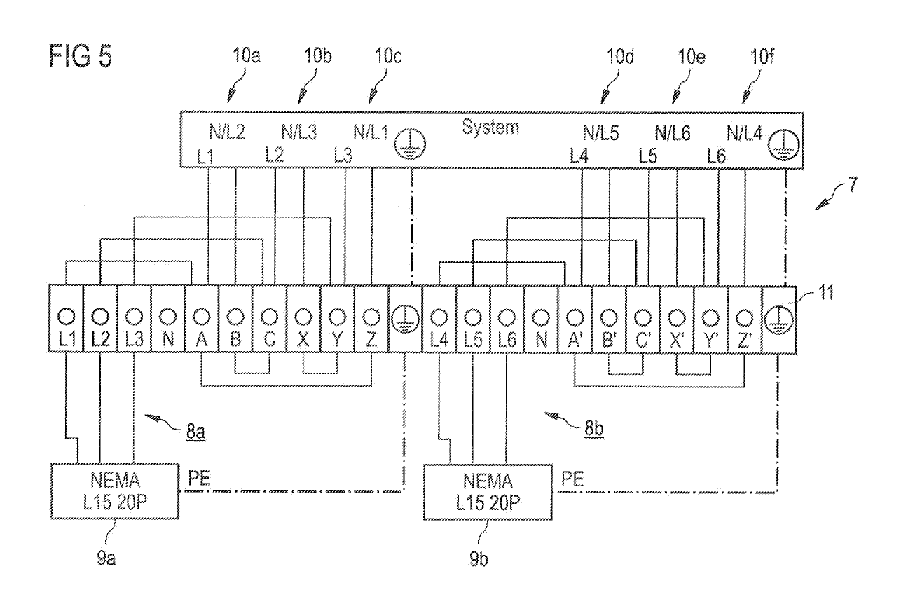

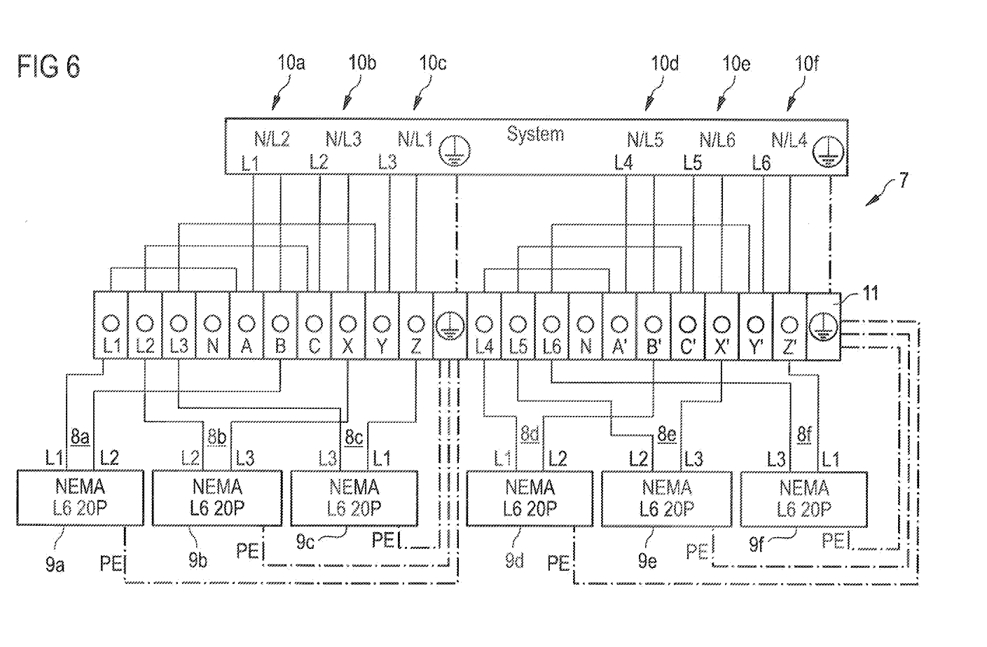

The connection schematics shown in FIGS. 2 to 4 are each designed for connection in a power network with a nominal voltage of 235 V between an individual phase line L1, L2, or L3 and a neutral conductor N. To protect the connection capability of the rack housing 1 without modifying the plug-in components 12 held in the rack housing 1 even in countries with different mains voltages, in the connection devices according to FIGS. 5 and 6, wiring is performed not between the individual phase lines L1 to L3 and a central neutral conductor N, but instead between different phase lines L1, L2, and L3.

FIG. 5 shows a connection schematic for the rack housing 1 for connection of the distributor device 7 to a three-phase power network without common neutral conductor. The first rack-internal connection line 10a of load zone A is connected between the phase lines L1 and L2 of an external connection line 8a or a so-called “NEMA L15” mains plug 9a. The connection line 10b for the second load zone B is connected between the phase lines L2 and L3. The third connection line 10c is connected between the phase line L3 and the phase line L1.

This connection schematic repeats itself for the other connection lines 10d to 10f of the fourth to sixth load zones D to F, wherein the individual phases of the same or another energy source are provided by a second NEMA mains plug 9b and a second mains line 8b. In this way it is produced, as explained with reference to FIG. 3, protection against the separation of one of the line power plugs 9a or 9b or the failure of an individual phase line.

As previously explained with reference to FIG. 4, also in the use of power networks without a common neutral conductor, an arrangement could be implemented with six mains lines 8a to 8f that are independent from each other and six NEMA L6 mains plugs 9a to 9f. This is shown in FIG. 6.

In three-phase, three-conductor power networks with a rated nominal voltage of approximately 100 V to 150 V for each phase, as are typical, for example, in the United States of America or Japan, by the shown wiring, an operating voltage of approximately 200 V can be tapped between two adjacent phases. In this way, a connection of a mid-point, neutral, or outer conductor of the three-conductor systems typical there is not necessary.

Therefore, an internal supply voltage for operation of the plug-in components 12 of approximately 200 V is provided by the distributor devices 7 shown in FIGS. 5 and 6 also in those power networks that feature only a mains voltage of, for example, 120 V. In this case, the use of different plug-in components 12 or a modification of the supply voltage by means of transformers can be eliminated.

Indeed, the generated internal operating voltage of approximately 200 V does not completely match the mains voltage typical in Europe of 235 V for each phase line. This can be compensated for, however, in that the plug-in components 12 are equipped with network units that exhibit a tolerance with respect to such a voltage deviation. For example, combinational circuit parts are known that operate reliably and efficiently in a supply-voltage range from approximately 180 to 270 V.

As follows from FIGS. 3 to 6, the internal connection devices, in particular, the connection lines 10a to 10f of the load zones A to F of the different plug-in positions 2 can be maintained for all configurations of the rack housing 1. Only the connection of the external mains lines 8 and the associated line power plug 9 are changed according to each connection schematic. This allows the construction of a rack housing 1 that is uniform worldwide, including the connection lines 10a to 10f. Preferably, the distributor device 7 also has a uniform construction and is preassembled in the rack housing 1.

Adaptation of the connection device to the local power network can be realized, for example, as shown in FIGS. 3 to 6, by primary-side wire bridges or cable connections to a connection block 11. For example, terminal blocks mounted on a top-hat rail are suitable for this purpose.

To be able to perform the adaptation in an especially simple and safe way, according to one alternative, a multi-pole plug connector is used between the connection block 11 and the mains line 8. The plug connector takes over, on the side of the mains line 8, both the connection of the individual phase lines L1 to L3 to the correct connection of the connection block 11 and also bridging of the individual connections of the connection block 11.

To establish electrical safety, in all of the connection schematics, an additional protective conductor PE can be provided in the mains lines 8, the mains plugs 9, the internal connection lines 10, and/or the distributor device 7. This is indicated in each of FIGS. 2 to 6 by a dash-dot line. The protective conductor PE is used exclusively for establishing electrical safety and does not influence the functionality of the described connection device.

Due to the most uniform possible distribution of the load zones A to F to the different phase lines L1 to L3 of one or more circuits of a building installation, the provision of additional, rack-internal safety devices can also be avoided. This has the advantage, in particular, that access to the distributor device in the interior of the rack housing 1 is not required. The rack housing 1 or its distributor device 7 uses the safety measures of the respective local energy source.

Although the apparatus and has been described in connection with specific forms thereof, it will be appreciated that a wide variety of equivalents may be substituted for the specified elements described herein without departing from the spirit and scope of this disclosure as described in the appended claims.

1. A connection arrangement for a rack housing with a plurality of load zones, comprising:
at least one internal connection device each having at least one phase conductor and one neutral conductor for each of the plurality of load zones, and
a distributor device that electrically couples the internal connection devices with at least two external lines that are electrically independent from each other for connection to different phases and/or different energy sources,
wherein each of the internal connection devices is coupled directly to the distributor device independent of the other internal connection devices, and the distributor device for distribution of a voltage of the at least two external lines to the individual load zones of the rack housing is arranged so that a voltage failure of an individual external line does not lead to failure of all of the load zones.

2. The connection arrangement according to claim 1, wherein the at least two external lines are included in different mains lines for independent connection to at least two energy sources, and the distributor device is arranged such that failure of one of the energy sources or separation of one of the different mains lines does not lead to failure of all of the load zones.

3. The connection arrangement according to claim 1, wherein the at least two external lines are different phase lines of one multi-phase mains line, and the distributor device is arranged such that failure of one of the phases does not lead to failure of all of the load zones.

4. The connection arrangement according to claim 2, wherein the distributor device is arranged to connect to at least two different phase lines of at least two different multi-phase mains lines so that failure of one of the phases and/or one of the energy sources does not lead to failure of all of the load zones.

5. The connection arrangement according to claim 1, wherein each of the load zones is supplied either by a voltage difference between one individual phase line and one common neutral conductor or by a voltage difference between two phases of one mains line with one operating voltage.

6. The connection arrangement according to claim 1, arranged to connect to different supply voltages, wherein the distributor device combines the different supply voltages with each other so that a plurality of the internal connection devices of the load zones are supplied with a substantially uniform operating voltage for use in the different power networks.

7. The connection arrangement according to claim 1, wherein the distributor device is arranged such that failure of one external line does not lead to failure of competing, adjacent, or complementary load zones.

8. A rack housing comprising:
a connection device according to claim 1, and
a plurality of plug-in positions each for holding one plug-in component, wherein the plug-in positions are electrically connected to different internal connection devices so that plug-in components held therein are allocated to different load zones.

9. The rack housing according to claim 8, wherein each of the plug-in positions has a plug connector for automatic connection of the plug-in components to the internal connection device of an associated load zone for insertion of a plug-in component into the plug-in position.

10. The rack housing according to claim 8, wherein the rack housing has at least two additional plug-in positions to hold redundant auxiliary components, and the at least two additional plug-in positions are electrically connected to different internal connection devices so that auxiliary components held therein are allocated to different load zones.

11. The rack housing according to claim 8, wherein the rack housing has at least one additional plug-in position to hold an auxiliary component, and the at least one additional plug-in position is electrically connected to at least two different internal connection devices so that one of the add-in components held therein is allocated to at least two different load zones.

12. The rack housing according to claim 8, wherein the internal connection devices and the distributor device are installed permanently in the server rack and at least one mains line comprising the at least two external lines is selected and installed as a function of a local connection configuration.

13. The connection arrangement according to claim 2, wherein the at least two external lines are different phase lines of one multi-phase mains line, and the distributor device is arranged such that failure of one of the phases does not lead to failure of all of the load zones.

14. The connection arrangement according to claim 3, wherein the distributor device is arranged to connect to at least two different phase lines of at least two different multi-phase mains lines so that failure of one of the phases and/or one of the energy sources does not lead to failure of all of the load zones.

15. The connection arrangement according to claim 13, wherein the distributor device is arranged to connect to at least two different phase lines of at least two different multi-phase mains lines so that failure of one of the phases and/or one of the energy sources does not lead to failure of all of the load zones.

16. The rack housing according to claim 9, wherein the rack housing has at least two additional plug-in positions to hold redundant auxiliary components, and the at least two additional plug-in positions are electrically connected to different internal connection devices so that auxiliary components held therein are allocated to different load zones.

17. The rack housing according to claim 9, wherein the rack housing has at least one additional plug-in position to hold an auxiliary component, and the at least one additional plug-in position is electrically connected to at least two different internal connection devices so that one of the add-in components held therein is allocated to at least two different load zones.

18. The rack housing according to claim 10, wherein the rack housing has at least one additional plug-in position to hold an auxiliary component, and the at least one additional plug-in position is electrically connected to at least two different internal connection devices so that one of the add-in components held therein is allocated to at least two different load zones.
